(19) United States
(12) Patent Application Publication
(10) Pub. No.: US 2003/0147429 A1
(43) Pub. Date: Aug. 7, 2003

(54) Data transfer interface for a switching network and a test method for said network

(76) Inventors: Karsten Laubner, Muenchen (DE); Franz Lindwurm, Muenchen (DE); Marcel-Abraham Troost, Muenchen (DE)

Correspondence Address: BELL, BOYD & LLOYD, LLC, P. O. BOX 1135, CHICAGO, IL, 60690-1135, US

(21) Appl. No.: 10/168,060

(22) PCT Filed: Dec. 12, 2000
(86) PCT No.: PCT/DE00/04409

(30) Foreign Application Priority Data
Dec. 17, 1999 (DE) 199 61 147.5

(51) Int. Cl. H04J 3/04

(52) U.S. Cl. 370/535

(57) ABSTRACT

The invention relates to a data transfer interface for a switching network and to a test method for said network. According to the invention, a plurality of test channels (syn0 bis syn3, asw0 bis asw9, tstch) are included in a synchronous time-division multiplex frame comprising a plurality of payload channels (payld). In addition, each channel has additional test bits. A secure data transfer interface is thus obtained, which can be used for online monitoring.

The present invention relates to a data communication interface for a switching network and an associated test method and, in particular, to a protected data communication interface for on-line monitoring of a voice memory in a switching network of a telecommunication switching system.

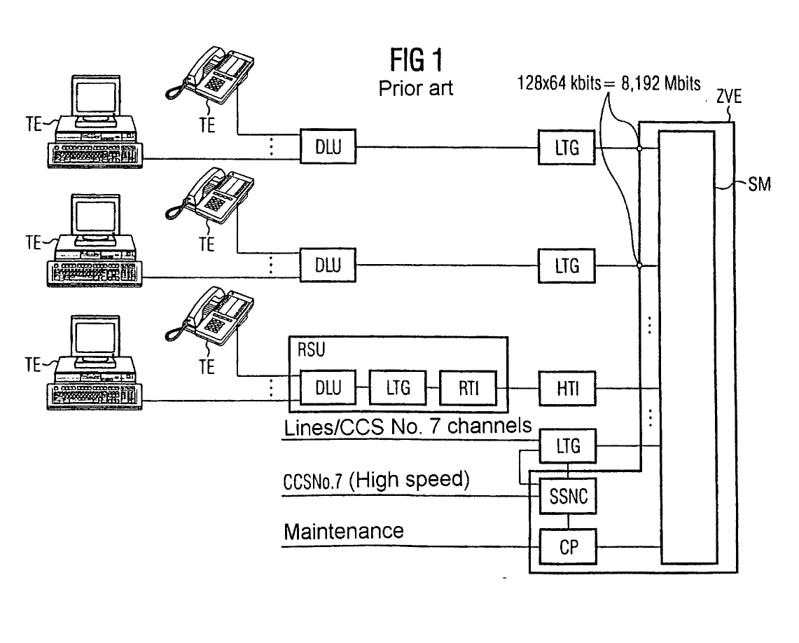

FIG. 1 shows a simplified block diagram of a digital telecommunication system according to the prior art which can be implemented, for example, by means of the Siemens EWSD switching system. Such a conventional telecommunication system consists of a central switching unit ZVE to which a multiplicity of line trunk groups LTG or an interface HTI (host time slot interchange) for connecting a remote switching unit RSU can be connected. A multiplicity of subscriber terminals TE can be connected to the respective line trunk groups LTG or the interface for the remote switching unit RSU via so-called digital line units DLU. The remote switching unit RSU has an interface RTI (remote time slot interchange) at the receiver end and a line trunk group LTG and a digital line unit DLU. Furthermore, line trunk groups can also be provided for linking the central switching unit ZVE to other central switching units, when preferably CCS No. 7 (common channel signaling No. 7) signaling protocols are passed on.

A data interface between line trunk group LTG and central switching unit ZVE usually has a capacity of 128 channels which preferably have a bandwidth of 64 kbit/s. This results in a total data rate of 8.192 Mbit/s. Such a data stream or the respective channels of the respective line trunk groups LTG, respectively, are then coupled to one another by a switching network SN by using a coordination processor CP and a signaling system network control SSNC, in such a manner that a data communication or link between the individual subscriber terminals TE is established.

Such a switching network consists of a multiplicity of module frames, modules and associated ASICS which implement the time-division switching units and space-division switching units necessary for the actual switching. Usually, a data communication interface known from the line trunk groups LTG is used for transmitting data in such a switching network.

The disadvantageous factors in such a conventional data communication interface are, however, that no protected data transmission takes place within the switching network, the number of junction lines between the individual switching units is relatively large and in addition only relatively expensive test methods are available for testing the individual switching units.

Printed document EP-A-0 895 371 describes a data communication interface for a switching network with a synchronous time-division multiplex frame for accommodating a multiplicity of data channels, the data channels of the synchronous time-division multiplex frame consisting of a multiplicity of payload channels and test channels and being expanded by additional test bits.

The payload channels are used for transmitting payload information. The test channels are used for transmitting switching information, dependability information and operating information, programs in the sense of loading components of the communication facility and frame clock and/or superframe clock information. However, simple checking or testing of call memories or voice memories located in switching networks, particularly in continuous operation, is not possible with this conventional interface and the associated method either.

The invention is, therefore, based on the object of providing a data communication interface and an associated test method which provides for an on-line check of call memories or voice memories located in switching networks in a simple manner.

This object is achieved by the features of the new claim 1 with regard to the interface and by the measures of the new claim 7 with regard to the method.

It is particularly by using memory address test channels, where an associated channel number is selected in such a manner that in each case only one address bit of respective memory addresses has the value “1”, that memory address supervision of a voice memory provided in the switching network can be implemented in a simple manner, which, in addition, can be performed during operation, that is to say without powering down the switching center. It is possible in this manner to detect and exchange any defective modules of the voice memory at any time and without problems.

Further advantageous embodiments of the invention are characterized in the further subclaims.

In the text which follows, the invention will be described in greater detail by means of an exemplary embodiment and referring to the drawing, in which:

FIG. 1 shows a simplified block diagram of a telecommunications system according to the prior art;

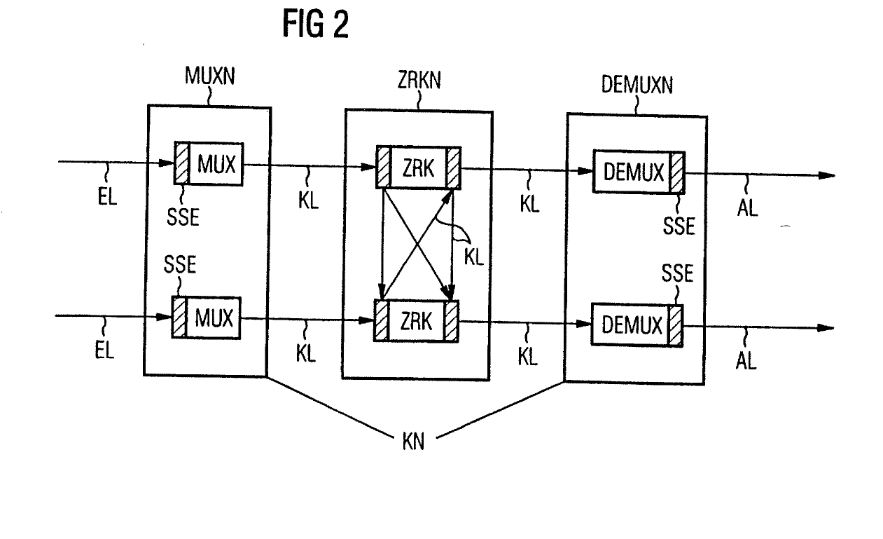

FIG. 2 shows a simplified block diagram of a switching network with the interface unit according to the invention;

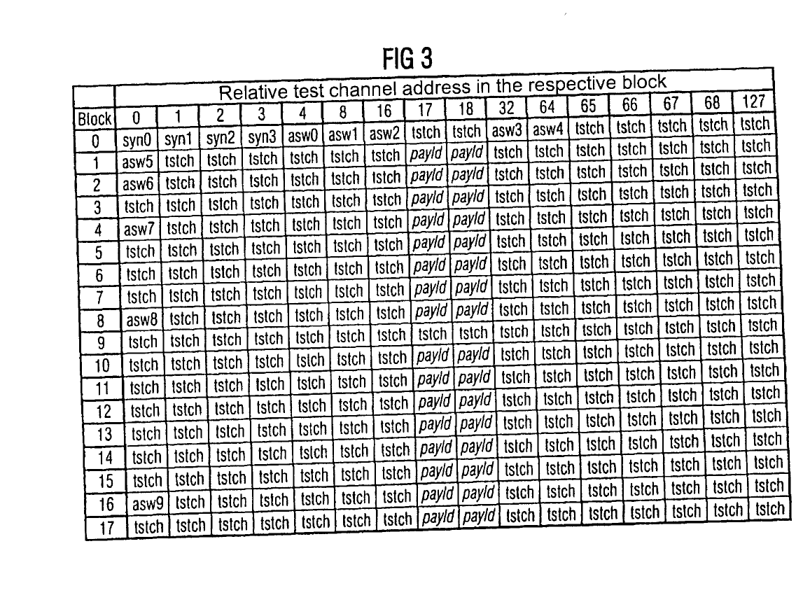

FIG. 3 shows a simplified representation of a frame structure of the interface unit according to the invention;

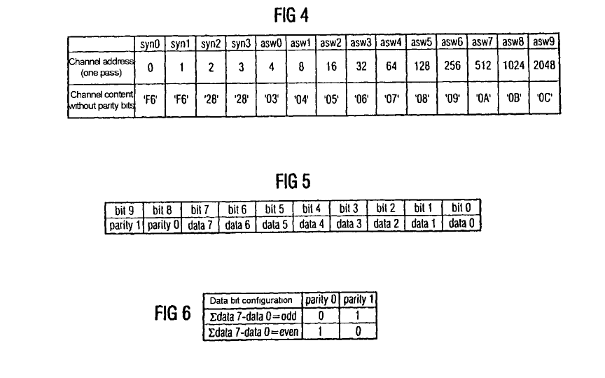

FIG. 4 shows an exemplary listing of the values of predetermined test channels of the frame structure of the interface unit according to the invention;

FIG. 5 shows a representation of the channel structure of the data channels contained in the frame structure of the interface unit according to the invention; and

FIG. 6 shows a representation of a parity mechanism used in the interface unit according to the invention.

FIG. 2 shows a simplified block diagram of a switching network as provided preferably in EWSD type D central switching units from Siemens. Such switching networks usually consist of a concentrator network KN with a multiplexer network MUXN and a demultiplexer network DEMUXN for compressing/demultiplexing data channels to be switched, and a time-division/space-division switching network ZRKN for allocating the data channels in time and space (actual switching). According to FIG. 2, data channels which are supplied to the switching network, for example via input lines EL in a time-division multiplex method, are first compressed by means of multiplexer stages MUX of the concentrator network KN (e.g. 16×128 data channels). The compressed data channels are then transmitted via the switching network line KL to the time-division/space-division switching network ZRKN or, respectively, the respective time-division/space-division switching units ZRK where the actual allocation (switching) of the data channels in time and space takes place. The spatial and temporal allocation can be performed in any manner. Finally, the allocated (or switched) channels are again conducted back to the concentrator network via the switching network line KL, where they are converted back into their original data format (e.g. 128 data channels at 64 kbit/s each) by means of demultiplexer stages DEMUX.

To implement the data communication interface according to the invention, there is an interface unit SSE preferably in each function unit but it can also be provided in only parts of the network. This interface unit SSE is used as a protected data communication interface in the switching network, by means of which at least the data channels to be switched can be transmitted in a protected manner. In addition, such an interface unit SSE, which can be constructed both as transmitting station and as receiving station, provides for on-line monitoring of the module frames, modules and ASICS present in the switching network. Furthermore, such a data communication interface enables the number of switching network lines KL to be reduced, as will be explained in detail in the text which follows.

FIG. 3 shows a simplified representation of the frame structure generated by the data communication interface implemented by the interface unit SSE. According to FIG. 3, data streams of approx. 184 Mbit/s are switched and the data streams consist of test channels tstch, syn, asw (2×128 data channels) and payload channels payld (16×128 data channels). FIG. 3 only shows a section of the entire frame structure (2304 data channels) and, in particular, the relative channel addresses 5 to 7, 9 to 15, 19 to 31, 33 to 63 and 69 to 126 are not shown in order to simplify the frame structure. Only the further payload channels payld in the switching network are transmitted via these further relative channel addresses of the synchronous time-division multiplex frame.

According to FIG. 3, the synchronous time-division multiplex frame accordingly contains 16×128 payload channels which are transmitted, for example, by 16 line trunk groups LTG and generated by the multiplexer stages MUX of the concentrator network. This 16-fold compression of the data volume of 128 data channels usually transmitted by the line trunk groups LTG already results in a considerable reduction in the switching network lines KL needed in the switching network.

The essential factor of the present invention is, however, the use of 2×128=256 test channels tstch, syn and aws which are essentially stored at the relative channel addresses 0 to 4, 8, 16 to 18, 32, 64 to 68 and 127. This results in a total of 2304 data channels which, in turn, are combined in 18 virtual blocks, i.e. block 0 to block 17 of 128 data channels each.

A further special feature of the present data communication interface is the width of the respective data channels. According to this, each data channel selected via a relative channel address now consists of 10 bits of data instead of usually 8 bits of data which results in an expansion of the data rate from 64 kbit/s to 80 kbit/s. The channel structure will be described in detail elsewhere.

In FIG. 3, a subset of the 256 test channels is particularly identified, where the test channels syn0 to syn3 are used for synchronizing the data communication interface according to the invention and the test channels asw0 to asw9 are available for memory address supervision. The further 242 test channels are available for other applications and, for example, three test channels can be used for a memory identification test.

The respective eight data bits of the test channels syn0 to syn3 for synchronization are preferably identical with the A1 and A2 sync words according to ITU (International Telecommunication Union) G.707/708 and are located at the relative channel addresses 0 to 3 of block 0. Using these sync words provides a synchronous time-division multiplex data communication interface with an extraordinarily high-data transmission rate, in which the payload channels to be switched can be transmitted or exchanged by using a minimum number of switching network lines KL. Accordingly, the individual module frames, modules and ASICs can be selected via in each case mutually independent clock supply units which synchronize to one another via the data communication interface according to the invention.

A further subset, i.e. asw0 to asw9, of the 256 test channels is used for memory address supervision and is distributed in a synchronous time-division multiplex frame in a particular manner. More precisely, a channel number or relative channel address of these memory address supervision words asw0 to asw9 (address supervision word channel) is selected in such a manner that the words are written to the same memory address in a respective call memory and/or voice memory (not shown) of a respective time-division/space-division switching stage ZRK of the switching network. This address is characterized in that in each case only one address bit has the value “1”.

For example, a so-called voice memory (not shown) of a respective space-division/time-division switching stage ZRK consists of 2304 memory cells which can be selectively addressed for implementing, for example, a time correlation. The addressing of these 2304 memory cells requires 12 address bits in consequence. The special arrangement of the memory address supervision words asw0 to asw9 in conjunction with the sync words syn1 and syn2 in the relative channel addresses 1, 2, 4, 8, 32, 64, 128, 256, 512, 1024, 2028 and 4096 thus provides for reliable checking of the memory addressing. A subsequent unit, for example the space-division/time-division switching stage ZRK, checks the data channels at its input for the relevant expected content and, in the case of a mismatch, an error register is incremented and can be forwarded to an external evaluating circuit. This makes it possible to reliably test the addressing of the (voice) memory cells of the respective units of the switching network with regard to their operability and correct selection.

A further monitoring mechanism which can be implemented, for example, by means of further test channels tstch, not specially marked, determines whether the various memory cells or units are correctly selected and do not generate any data errors. For this purpose, for example, an interface unit SSE at the transmitting end generates a specific data pattern in each synchronous time-division multiplex frame in a particular test channel and this data pattern is different for each output. On the other hand, each of these test channels to be monitored is again switched through to each output in an interface unit SSE at the receiving end and a particular (programmable) pattern is checked in dependence on the switching-through at the output to establish whether the correct memory unit or cell (e.g. voice memory) is switched through to the correct output. This makes it possible thus to check the correct operation of a respective time-division switching unit ZK during its operation, i.e. on-line.

FIG. 4 shows a tabular representation of exemplary numerical values for the test channels syn0 to syn3 and asw0 to asw9 for synchronizing and memory address supervision, described above.

According to this, the eight data bits of the sync words for synchronization correspond to the A1 and A2 sync words according to ITU G.707/708. It should be pointed out that the channel contents are shown hexadecimally without the additional test bits used for the parity check. For the data words of the memory address supervision asw0 to asw9 (address supervision word channel), those channel contents which enable a direct conclusion to be drawn regarding the respectively selected address line of a memory element or memory unit to be tested are preferably used. As has already been described above, the channel numbers or relative channel addresses of these address words are also selected in such a manner that they are always written to the same address in a space-division switching unit and/or time-division switching unit and only one address bit in each case has the value “1”. This results in the relative channel addresses 4, 8, 16, 32, 64, 128, 256, 512, 1024 and 2048 (see also FIG. 3).

FIG. 5 shows a simplified representation of a channel structure of the data channels used in the frame structure according to FIG. 3. Accordingly, both a payload channel payld and a test channel tstch, syn0 to syn3 and/or asw0 to asw8, consists of 10 bits and bit 9 is preferably transmitted first and bit 0 last. According to FIG. 5, the bits 9 and 8 transmitted first form additional test bits for each data channel. These additional test bits 9 and 8 are preferably used for a parity check and parity bit 1 is transmitted in bit 9 and parity bit 0 is transmitted in bit 8.

The two parity bits 0 and 1 are generated by physically separate blocks according to the mechanism shown in FIG. 6. If, accordingly, the sum of data bits 0 to 7 is odd-numbered, parity bit 0 is set to zero and parity bit 1 is set to one. If, in contrast, the sum of data bits 0 to 7 is even-numbered, parity bit 0 is set to one and parity bit 1 is set to zero. This makes it possible to perform on-line monitoring individually for each channel and, with the appropriate construction, it can also be made possible to locate a respective data transmission error in the system.

Thus, disturbances can be located rapidly and in a simple manner particularly in the implementation of so-called dedicated lines which are switched through once by a switching system. In addition, however, error processing with conventional error processing routines is also possible which makes possible and simplifies the implementation of the data communication interface according to the invention with extraordinarily high data rates.

To prevent synchronization information from being simulated, which may occur in particular with high data rates (frequencies), the channel-related data protection of the synchronization words syn0 to syn3 is preferably performed by means of a mathematical method which is different from the mathematical method of the remaining data channels asw0 to asw3, tstch and payld. The parity bits 1 and 0 in the sync words syn0 to syn3 are preferably inverted, which results in an unambiguous distinction from the remaining data words.

When an error occurs in the parity check or during the checking of the test bits, the channel contents of the payload channels payld are preferably replaced by an “idle code” and transmitted onward. This prevents a propagation of the error in the system and the disturbance can be located in a particularly simple and quick manner. On the other hand, the channel contents of the test channels syn0 to syn3 and asw0 to asw9, which are known for a system in any case, can be regenerated when an error occurs in the parity check which is why a complete check can be performed in the switching network even with partially defective units. Accordingly, prior allocation of standard contents to particular test channels enables the switching network to be functionally checked down to its individual modules and ASICs.

The invention has been described above by means of a 184 Mbit/s frame signal. However, it is not restricted to this and, instead, includes all other frame structures which have additional test bits and test channels for the channel-related and multi-channel monitoring and/or protection.

1. A data communication interface for a switching network comprising
a synchronous time-division multiplex frame for accommodating a multiplicity of data channels, wherein the data channels of the synchronous time-division multiplex frame consist of a multiplicity of payload channels (payld) and test channels (syn0 to syn3, asw0 to asw9, tstch) and are expanded by additional test bits (parity0, parity1), characterized in that some of the test channels (asw0 to asw9) are used for memory address supervision, wherein
a channel number of the test channels (asw0 to asw9) for memory address supervision is selected in such a manner that in each case only one address bit of respective memory addresses has the value “1”.

2. The data communication interface as claimed in claim 1, characterized in that each data channel consists of 10 bits, the first two bits transmitted representing the additional test bits (parity0, parity1).

3. The data communication interface as claimed in claim 1 or 2, characterized in that some of the test channels (syn0 to syn3) are used for synchronization.

4. The data communication interface as claimed in one of claims 1 to 3, characterized in that some of the test channels (tstch) are used for a memory identification test.

5. The data communication interface as claimed in one of claims 1 to 4, characterized in that the additional test bits of the test channels (syn0 to syn3) for the synchronization are inverted with respect to the additional test bits of the remaining data and test channels (asw0 to asw9, tstch, payld).

6. The data communication interface as claimed in one of claims 1 to 5, characterized in that the synchronous time-division multiplex frame 18 exhibits virtual blocks of in each case 128 channels and a data rate of approx. 184 Mbit/s.

7. A method for testing a switching network comprising a multiplicity of time-division switching units (ZK) and space-division switching units (RK), consisting of the following steps:
a) expanding payload and test channels by additional test bits (parity0, parity1);
b) determining a test sum of data bits of the respective data channels to be transmitted and correspondingly specifying the test bits;
c) transmitting the test bits and the data bits in the respective data channels;
d) determining a test sum of the transmitted data bits; and
e) evaluating the test sum determined and the test bits transmitted in order to detect errors,
wherein
channel numbers of test channels (asw0 to asw9) for memory address supervision are selected in such a manner that only one predetermined address in which only one address bit in each case of respective memory addresses has the value “1”, of a time-division and/or space-division switching unit (ZK, RK) is described, and a corresponding data channel content is checked for correspondence at a downstream time-division and/or space-division switching unit.

8. The method as claimed in claim 7, characterized in that an error register in a unit is incremented in the case of a mismatch.

9. The method as claimed in one of claims 7 or 8, characterized in that the evaluation in step e) for synchronization test channels (syn0 to syn3) is performed by means of a mathematical method which differs from a mathematical method for the remaining payload and test channels (payld, asw0 to asw9, tstch).
